(19) United States
(12) Patent Application Publication
(10) Pub. No.: US 2003/0230159 A1
(43) Pub. Date: Dec. 18, 2003

(54) Power brake lock

(76) Inventors: Richard R. Rose, Edison, NJ (US); David R. Rose, Edison, NJ (US)

Correspondence Address: Ralph W. Selitto, Jr., 203 Main Street, Metuchen, NJ, 08840-2727, US

(21) Appl. No.: 10/461,707

(22) Filed: Jun. 13, 2003

Related U.S. Application Data
(60) Provisional application No. 60/388,797, filed on Jun. 14, 2002.

(51) Int. Cl. G05G 11/00

(52) U.S. Cl. 74/482; 74/481

(57) ABSTRACT

A device for locking a brake pedal of a motor vehicle includes a cylinder and a piston mounted for reciprocating movement relative to each other. A spring is positioned within the cylinder so as to urge the piston away from a retracted position and towards an extended position. The external end of the piston is adapted to engage an exposed surface of a motor vehicle's brake pedal, containing an antifriction member such as a toothed tip integrally formed therewith or a separate rubber cap attached thereto. The cylinder further includes a hook member or some other mechanism adapted to engage a front surface of a motor vehicle's driver seat. The position of the hook member on the cylinder is adjustable so as to accommodate varying distances between the brake pedal and the driver seat.

### CROSS-REFERENCE TO RELATED APPLICATION

This application is a §111 (a) application relating to commonly owned co-pending U.S. Provisional Application Serial No. 60/388,797, entitled “Power Brake Lock,” filed Jun. 14, 2002.

### FIELD OF THE INVENTION

The present invention relates to locking devices and, more particularly, to devices used to lock down brake pedals of motor vehicles used during the launch and retrieval of boats from and onto boat trailers connected to the vehicles.

### BACKGROUND OF THE INVENTION

Various types of motor vehicle foot pedal locking devices have been proposed in the past. Dunham U.S. Pat. No. 3,722,266 (“Dunham '266 Patent”) discloses a tool for temporarily holding down an automobile brake pedal. The brake tool disclosed in the Dunham '266 Patent contains a flat end plate fitted on one end of a tubular member, and, when the brake tool is engaged, the plate is positioned against the front side of an automobile's driver seat. The Dunham '266 Patent, however, does not disclose that the plate is flexible so as to enable the entire surface of one side of the plate to remain in constant contact with the driver's seat. As a result, the brake tool may not always maintain the correct or constant pressure on the brake pedal.

The Dunham '266 Patent also discloses the use of a smooth rubber boot fitted on one end of a solid metal bar that is placed on the brake pedal. However, the use of this type of boot may slip off the brake pedal, especially in wet conditions.

The Dunham '266 Patent also discloses that a compression coil spring exerts force against a collar when the brake tool is engaged. However, the Dunham '266 Patent does not disclose any means for preventing the spring from wearing out the collar over an extended period of use of the brake tool.

In addition, the brake tool disclosed in the Dunham '266 Patent is not adjustable to fit vehicles with having different distances between the bottom of the vehicle's driver seat and the brake pedal. As a result, this brake tool does not control the correct brake pressure from vehicle to vehicle. Finally, the brake tool disclosed in the Dunham '266 Patent does not extend above the front of the vehicle's driver seat when in operation. As a result, it is more difficult for an operator of the vehicle to engage or disengage the brake tool from a normal driving position.

Phillips U.S. Pat. No. 3,910,135 (“Philips '135 Patent”) discloses an accelerator pedal holding device. The Phillips '135 Patent discloses the use of a threaded rod to enable the accelerator pedal holding device to be adjusted to fit a variety of motor vehicles. However, the threaded rod is rigid and, therefore, does not compensate for any “pulsing” of the vehicle's accelerator pedal while the vehicle's engine is running. As a result, this accelerator pedal holding device may not always maintain the desired predetermined position of the accelerator pedal.

Neither the Dunham '266 Patent nor the Phillips 135 Patent discloses means that enable operators of the respective devices to easily and comfortably exert ample downward pressure from the top of each device. Without such means, operators of the devices may be inclined to grasp the main body of the devices to push down in an effort to engage the devices. This may result in the operator losing his grip on the devices.

### SUMMARY OF THE INVENTION

The problems and disadvantages associated with the prior art are overcome by the present invention, which includes a cylinder and a piston mounted for reciprocating movement relative to each other. More particularly, the piston is moveable between an extended position, in which an external or free end of the piston is remote from the cylinder, and a retracted position, in which the external end of the piston is proximate to the cylinder. A spring or some other urging mechanism is positioned within the cylinder so as to urge the piston away from its retracted position and towards its extended position. The external end of the piston is adapted to engage an exposed surface of a motor vehicle's brake pedal. The cylinder includes a hook member or some other mechanism adapted to engage an exposed surface of a motor vehicle's driver seat. The position of the hook member on the cylinder is adjustable so as to accommodate varying distances between the brake pedal and the driver seat.

In use, the present invention functions to lock down a motor vehicle's brake pedal when a boat is being launched or retrieved from or onto a boat trailer, which is connected to the vehicle, at a boat launch ramp. Frequently, the vehicle is vacant while the operator is launching or retrieving the boat from the trailer. For vehicles containing automatic transmissions, the operator will typically place the vehicle in “Park” and may apply the vehicle's emergency brake in order to prevent the vehicle from moving during the launch or retrieval of the boat. For vehicles containing manual transmissions, the operator would simply engage the parking brake (which only locks the rear wheels of the vehicle) to prevent the vehicle from moving. However, an operator of any type of vehicle would typically want additional security that all four wheels of the vehicle will not move when launching or retrieving the boat. For example, when a boat is drawn onto a boat trailer, the weight of the boat is primarily on the back of the trailer and the front of the trailer tends to lift the back of the tow vehicle. In turn, the vehicle's weight on the rear wheels decreases and the weight on the front wheels increases. The grip of the rear wheels is significantly reduced due to this weight transfer. As a result, use of the parking brake as the only means to keep the vehicle stationary is not effective. The present invention solves this problem by employing a spring and a piston, which cooperate to lock down the vehicle's brake pedal. As a result, constant pressure is maintained on the brake pedal and, thus, the vehicle's brakes are applied to all wheels.

Also, wet conditions are prevalent at boat launch and retrieval sites. As a result, the vehicle's foot pedals usually become wet and slippery from the operator's wet shoes or feet. In these wet conditions, there is a concern that a foot pedal holder that includes a smooth tip will slip off a wet pedal. The present invention employs an antifriction mechanism at the external end of the piston, which enables it to firmly grip the exposed surface of the vehicle's brake pedal, especially in those wet conditions frequently encountered at boat launch sites.

In addition, an operator will typically keep the vehicle's engine running while he or she launches or retrieves the boat. However, the vibrations of a running engine can cause the vehicle's brake pedal to “pulse.” This frequently occurs in vehicles containing power assisted, hydraulic brake systems. As a result, there is a concern that a brake pedal holding device would not maintain constant pressure on the brake pedal while pulsing occurs. As described in greater detail below, the invention, by use of a spring or other urging mechanism, ensures that the correct and constant pressure is always maintained on the brake pedal, even when the brake pedal is pulsing.

Finally, not all vehicles and their operators are alike. Different vehicles have driver seats that are different in size, shape and style. Furthermore, the operators have different heights and leg lengths, resulting in a vehicle's driver seat being adjusted to accommodate the operator's height and leg length. Therefore, there is a need for a brake pedal holder to be as accommodating. The present invention employs an adjusting mechanism that allows for it to be adjusted for use between different types of vehicles and different driver seat positions, while maintaining the correct and constant pressure of the brake pedal.

Although the present invention has been adapted for use when launching and retrieving a boat from or onto a boat trailer and in wet conditions, the present invention can be utilized in other scenarios, environments and conditions.

Further features and advantages of the invention will appear more clearly on a reading of the detailed description of a preferred embodiment of the invention, which is given below by way of example only with reference to the accompanying drawings.

### BRIEF DESCRIPTION OF THE DRAWINGS

For a better understanding of the present invention, reference is made to the following detailed description of an exemplary embodiment considered in conjunction with the accompanying drawings, in which:

FIG. 1 is a perspective view of the power brake lock constructed in accordance with an exemplary embodiment of the present invention;

FIG. 2 is a side cross-sectional view, taken along section line II-II and looking in the direction of the arrows, of the power brake lock shown in FIG. 1;

FIG. 3 is a side view of the power brake lock of FIGS. 1 and 2 which shows the present invention in use; and

FIG. 4 is a cross-sectional view, taken along section line IV-IV and looking in the direction of the arrows, of the power brake lock of FIG. 3 that shows the present invention in use.

### DETAILED DESCRIPTION OF THE DRAWINGS

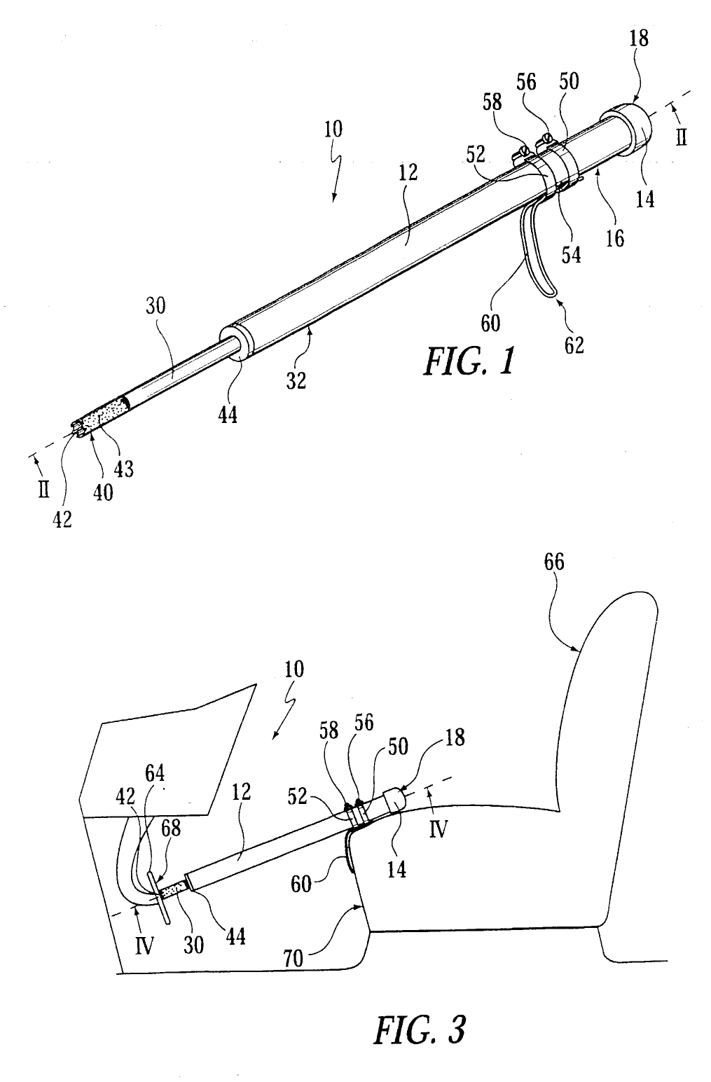

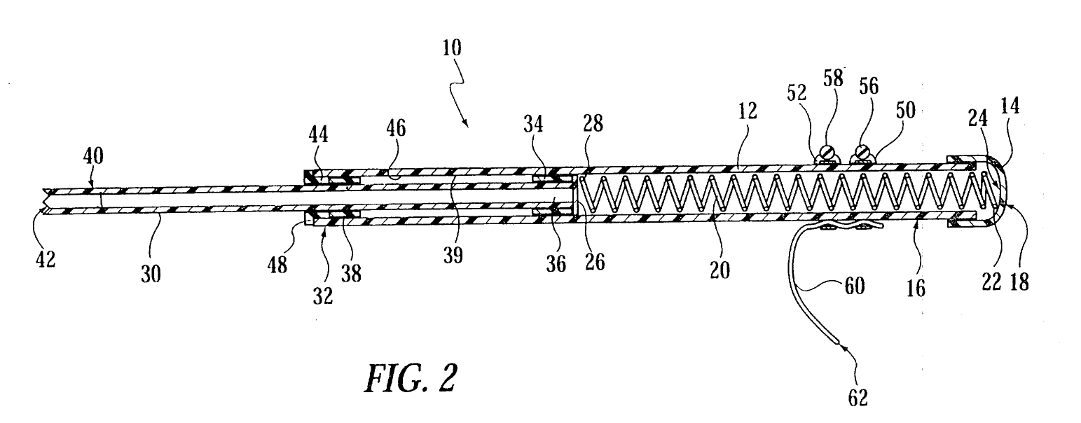

Referring to FIGS. 1 and 2, a power brake lock 10 includes a cylinder (i.e., tubular member) 12 that is rigid and hollow. The cylinder 12 is a base for other components of the power brake lock 10. For instance, a cap 14 is firmly mounted on an upper end 16 of the cylinder 12, the cap 14 having a rounded outer surface 18 for a purpose to be described hereinafter.

A compression coil spring 20 is slidably positioned within the cylinder 12. An upper end 22 of the spring 20 abuts against an inside surface 24 of the cap 14. A washer 26 is positioned inside the cylinder 12 and abuts against a lower end 28 of the spring 20.

A piston 30 is slidably mounted in a lower end 32 of the cylinder 12 for reciprocating movement relative thereto. The piston 30 contains a first collar 34, which is fitted around and attached proximate to an upper end (i.e., internal end) 36 of the piston 30. The first collar 34 functions as a piston ring to promote the centering of the piston 30 within the cylinder 12. The washer 26 prevents the lower end 28 of the spring 20 from wearing out the first collar 34 over an extended period of use of the power brake lock 10. The piston 30 also contains a second collar 38, which is fitted around and attached to the piston 30 remote from the upper end 36 of the piston 30, and is spaced apart from the first collar 34. The location where the second collar 38 is attached to the piston 30 determines how far the piston 30 extends outward from the lower end 32 of the cylinder 12. The second collar 38 also functions as a piston ring to promote the centering of the piston 30 within the cylinder 12.

A lower end (i.e., external end) 40 of the piston 30 has a toothed tip 42 integrally formed therein for a purpose to be described hereinafter. The lower end 40 of the piston 30 also includes a colored mark 43 of a predetermined length that longitudally extends from the tip 42, and circumferentially around the lower end of the piston 30. The mark 43 functions as an indicator to show that the power brake lock 10 is properly adjusted when engaged. In any event, the color of the mark 43 is preferably black, but other colors or shades can be utilized. The color of the mark 43 should be different than that of the piston 30.

A flanged insert 44 is secured within an opening 46 of the lower end 32 of the cylinder 12 and around the piston 30. The insert 44 has a radially extending flange 48, which abuts against the lower end 32 of the cylinder 12. The insert 44 cooperates with the second collar 38 to limit the distance the piston 30 extends outward from the opening 46 of the lower end 32 of the cylinder 12. The insert 44 also promotes the centering of the piston 30 within the cylinder 12.

A pair of adjustable band clamps 50 and 52 is fitted around the outer-surface 54 of the cylinder 12. Each band clamp 50 and 52 contains a tightening screw 56 and 58. The tightening screws 56 and 58 are preferably worm-drive screws.

A stop hook 60 is mounted to the outer surface 54 of the cylinder 12 by the band clamps 50 and 52. The band clamps 50 and 52 allow the stop hook 60 to be adjusted and secured in any location around the outer surface 54 of the cylinder 12. Other attachment means are available to adjust and secure the stop hook 60 to the outer surface 54 of the cylinder 12.

In a preferred embodiment of the invention, the cylinder 12, the cap 14, the piston 30, the collars 34 and 38 and the insert 44 are manufactured from Schedule 40 PVC or gray electrical conduit and the washer 26 is manufactured from steel. However, these components may be made from other materials. Preferably, the cap 14 and the insert 44 are secured to the cylinder 12 and the collars 34 and 38 are secured to the piston 30 with PVC glue. However, the cap 14 and the insert 44 can be secured to the cylinder 12, and the collars 34 and 38 can be secured to the piston 30 by other adhesives or by other means.

Furthermore, the ideal dimensions of the cylinder 12 are approximately 23.75 inches in length, 1.315 inches outside diameter and 1.049 inches inside diameter, with the ideal dimensions of the piston 30 being 21.5 inches in length overall, 0.840 inches outside diameter and 0.622 inches inside diameter. In addition, the clearance between the outside surfaces of the collars 34 and 38 and an inside surface 39 of the cylinder 12 is preferably 0.02 to 0.03 inches. Similarly, the clearance between the inside surface of the insert 44 and outside surface of the piston 30 is ideally 0.02 to 0.03 inches. The dimensions of these components, however, may be altered accordingly.

In an exemplary embodiment, the spring 20 is made from 0.080 inch steel wire, is 0.875 inches in diameter and 12 inches long, contains approximately 3.3 coils per inch, and has a spring constant of 3.5 pounds per inch or 42 pounds overall when fully compressed. The dimensions and characteristics of the spring 20 can be altered.

Preferably, the band clamps 50 and 52 are #301 stainless steel bands and are 0.023 inches thick. The tightening screws 56 and 58 are preferably made from zinc-plated steel, but they can be made from other materials.

Finally, the stop hook 60 is preferably made of hardened steel wire with a 5/32-inch diameter, and may contain a chrome finish. Alternatively, the stop hook 60 can be made from other materials and have a different diameter size and appearance. The distance between the outer-surface 54 of the cylinder 12 and the outward tip 62 of the stop hook 60 is preferably 3.5 inches. The length of the stop hook 60 can be increased or decreased as desired.

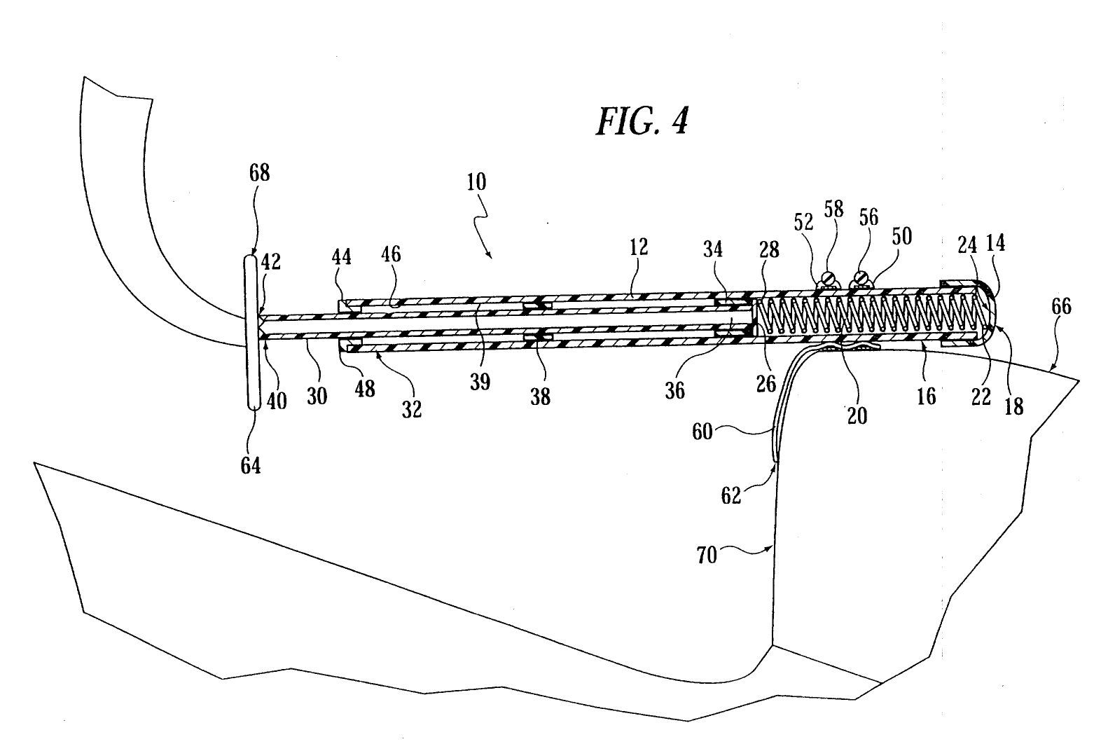

In use, as shown in FIG. 3 and FIG. 4, the power brake lock 10 is placed in contact between a motor vehicle's brake pedal 64 and driver seat 66. The stop hook 60 can be adjusted and secured in any position around the outer surface 54 of the cylinder 12. This allows the power brake lock 10 to be used in connection with different types of vehicles or different positions of a vehicle's driver seat 66. To adjust the position of the stop hook 60 along the cylinder 12, the tightening screws 56 and 58 are loosened which, in turn, loosens the band clamps 50 and 52. This enables the stop hook 60 to slidably move along the outside surface 54 of the cylinder 12 and be positioned accordingly. Once the stop hook 60 is adjusted, the tightening screws 56 and 58 are tightened which, in turn, tightens the band clamps 50 and 52 around the outside surface 54 of the cylinder 12 and the stop hook 60 until the stop hook 60 is firmly secured.

The toothed tip 42 is placed against the outer surface (i.e., exposed surface) 68 of the brake pedal 64. The toothed tip 42 securely grips the outer surface 68 of the brake pedal 64 so as to prevent the power brake lock 10 from slipping off the brake pedal 64, especially in wet conditions typically encountered at boat launch sites. Preferably, the power brake lock 10 is positioned perpendicularly to the outer surface 68 of the vehicle's brake pedal 64 so that the entire surface area of the toothed tip 42 abuts the outer surface 68 of the brake pedal 64. By placing the power brake lock 10 in this position, maximum efficiency of the toothed tip's 42 gripping capability of the outer surface 68 of the brake pedal 64 is achieved. Alternatively, the lower end 40 of the piston 30 can include other antifriction mechanisms formed therein or attached thereto adapted to grip the outer surface 68 of the brake pedal 64, such as a rubber pad or a rubber cap (not shown in the Figures).

Thereafter, a user of the device exerts downward pressure against the cap 14. The cap 14 enables a user to comfortably grip the power brake lock 10 and easily exert ample downward pressure when using the device. Preferably, the outer surface 18 of the cap 14 is rounded so as to provide extra comfort for an operator using the device. Alternatively, the cap 14 can have other shapes and sizes. As pressure is exerted, the cylinder 12 slides over the piston 30, which remains substantially stationary. The collars 34 and 38 keep the piston 30 centered within the cylinder 12 as the cylinder 12 slides over the piston 30. As the cylinder 12 slides over the piston 30, the spring 20 is compressed between the inner surface 24 of the cap 14 and the washer 26. Downward pressure is continuously increased until the brake pedal 64 is fully depressed and the stop hook 60 clears the bottom front surface 70 of the driver seat 66 so as to be enable the stop hook 60 to abut against said surface 70. At this point, the piston 30 is situated in a retracted position.

Once the power brake lock 10 is in position to enable the stop hook 60 to be placed against the bottom front surface 70 of the driver's seat, the user releases pressure against the cap 14. As pressure is released from the cap 14, the spring 20 expands. Upon expansion of the spring 20, the upper end 22 of the spring 20 exerts force against the inside surface of the 24 of the cap 14 and the lower end 28 of the spring 20 exerts force against washer 26 which, in turn, exerts force against the first collar 34. As a result, the cylinder 12 slides upward and away from the piston 30 and the piston 30 is urged towards an extended position. Alternatively, other urging mechanisms, such as a leaf spring or a pneumatic mechanism, can be utilized to urge the piston 30 towards its extended position.

The cylinder 12 slides upward until the stop hook 60 abuts against the bottom front surface 70 of the seat 66. The stop hook 60 may be shaped so as to conform to the shape of the bottom front surface 70 of the driver seat 66. This allows for the power brake lock 10 to maintain the correct and constant pressure on a brake pedal 64. Alternatively, other mechanisms adapted to engage the driver seat 66 can be utilized. The mark 45 functions as an indicator to show that the power brake lock 10 is properly adjusted when engaged. Ideally, the flange 48 lines up with the top of the mark 43 when the power brake lock 10 is engaged. When engaged in this manner, the power brake lock 10 applies the correct amount of pressure on the brake pedal 64. Alternatively, other indicia may be utilized to show that the power brake lock 10 is properly adjusted when engaged.

As the power brake lock 10 is engaged, constant pressure is maintained on the brake pedal 64 and the vehicle's brakes are applied. This allows an operator to exit the vehicle to launch or retrieve his boat from or onto the trailer connected to the vehicle with the assurance that the vehicle's brakes are applied and the vehicle's wheels will not move. Also, the piston 30 and the spring 20 cooperate with each other to allow the device to compensate for any pulsing of the brake pedal 64 while the vehicle's engine is running. This allows for the power brake lock 10 to maintain the correct and constant pressure on the brake pedal 64. Also, when engaged, the power brake lock 10 extends above the front of the seat 66. This enables the vehicle's operator to engage and disengage the power brake lock 10 from a normal driving position.

It should be understood that the embodiments described herein are merely exemplary and that a person skilled in the art may make many variations and modifications without departing from the spirit and scope of the invention. Accordingly, all such variations and modifications are intended to be included within the scope of the invention as defined in the appended claims.

What is claimed is:

1. A device for locking a brake pedal of a motor vehicle, comprising a cylinder having a first end and a second end opposite said first end; a piston mounted in said cylinder for reciprocating movement relative thereto, said piston having an internal end positioned internally of said cylinder and an external end positioned externally of said cylinder, said piston being movable between an extended position, in which said external end of said piston is remote from said first end of said cylinder, and a retracted position, in which said external end of said piston is proximate to said first end of said cylinder; urging means positioned within said cylinder for urging said piston towards its said extended position; first engaging means at said external end of said piston for engaging an exposed surface of a brake pedal of a motor vehicle; second engaging means, positioned on said cylinder, for engaging a driver seat of the motor vehicle; and adjusting means for adjusting the position of said second engaging means on said cylinder, whereby the position of said second engaging means relative to said cylinder can be varied to accommodate varying distances between the brake pedal and the driver seat.

2. The device as claimed in claim 1, wherein said second engaging means includes a hook member extending outwardly from said cylinder on one side thereof.

3. The device as claimed in claim 2, wherein said hook member is sized and shaped to conform to a front surface of the driver seat.

4. The device as claimed in claim 3, wherein said adjusting means further includes at least one band clamp extending around said cylinder and securing said hook member to said cylinder.

5. The device as claimed in claim 1, further comprising a cap mounted on said second end of said cylinder, said cap having an interior surface and an exterior surface.

6. The device as claimed in claim 5, wherein said exterior surface of said cap is rounded in order to provide manual comfort to a user of said device.

7. The device as claimed in claim 5, wherein said urging means includes a spring positioned within said cylinder, said spring being interposed between said internal end of said piston and said interior surface of said cap.

8. The device as claimed in claim 1, wherein said first engaging means includes a toothed tip formed integrally in said external end of said piston and adapted for gripping an exposed surface of the brake pedal.

9. The device as claimed in claim 1, wherein said first engaging means includes an antifriction member attached to said external end of said piston.

10. The device as claimed in claim 9, wherein said antifriction member includes a rubber cap.

11. The device as claimed in claim 1, further comprising indicating means proximate said external end of said piston for indicating a preferred position of said piston when said piston is in its said retracted position.

12. The device as claimed in claim 11, wherein said indicating means includes indicia positioned on said external end of said piston, said indicia is alignable with said first end of said cylinder when said piston is in said preferred position.

13. The device as claimed in claim 11, further comprising centering means for centering said piston within said cylinder.

14. The device as claimed in claim 13, wherein said centering means includes a first collar fitted around and mounted to said piston.

15. The device as claimed in claim 14, wherein said first collar is mounted proximate to said internal end of said piston.

16. The device as claimed in claim 15, wherein said centering means includes a second collar fitted around and mounted to said piston remote from said internal end of said piston.

17. The device as claimed in claim 16, further comprising a third collar mounted on said first end of said cylinder, said third collar being engageable by said second collar when said piston is in its said extended position, whereby said second and third collars cooperate to define a fully extended position of said piston.

18. The device as claimed in claim 17, wherein said piston is in a fully retracted position when said external end of said piston is in alignment with said third collar.

19. The device as claimed in claim 18, wherein said preferred position is intermediate said fully extended position and said fully retracted position of said piston.
